(19) United States
(12) Patent Application Publication
(10) Pub. No.: US 2010/0028697 A1
(43) Pub. Date: Feb. 4, 2010

(54) METHOD OF COATING METAL STRIPS

(75) Inventors: Rene Koschabek, Mannheim (DE); Martin Bartmann, Recklinghausen (DE); Thorsten Brand, Marl (DE); Andreas Schubert, Marl (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/520,999

(22) PCT Filed: Sep. 13, 2007
(86) PCT No.: PCT/EP07/59643

§ 371 Date: Jun. 24, 2009

(30) Foreign Application Priority Data
Dec. 29, 2006 (DE) 10 2006 062 041.0

(51) Int. Cl. B32B 15/09; C08G 63/00; C08G 63/12; C08G 63/181; C08G 63/183; C08G 63/199; C08L 67/00; B05D 3/02

(52) U.S. Cl. 428/458; 528/271; 528/272; 528/308; 528/308.6; 528/307; 524/599; 427/388.2

(57) ABSTRACT

The present invention relates to the use of branched, amorphous, polyester-based macropolyols for coating metal strips, to methods of coating metal strips and to the coated metal strips thus obtained. The coating comprises branched polyesters having trifunctional branching agent contents of between 10 and 25 mol %, based on the alcohol component, and the molecular weight of the polyester is between 2500 and 4500 g/mol.

The present invention relates to the use of branched, amorphous, polyester-based macropolyols for coating metal strips (coil coating), to methods of coating metal strips and to the coated metal strips thus obtained.

### BACKGROUND OF THE INVENTION

Coatings on metal strips are used to provide coiled metal sheets made of aluminium or steel, for example, in a very short time, and hence economically, with a high-grade coating. As compared with other coating methods, spraying, for example, this method has considerable advantages. Thus, with this method, high-quality, uniform coatings are achieved with a high yield and low emissions.

The coating of metal strips is a continuous process. In order to ensure the continued running of the coating operation at the end of one metal strip, devices known as accumulators are used, from which the strip can continue to be fed for a limited period of time while the next metal strip is being attached. The metal strips are generally cleaned beforehand, pretreated and provided with primers on both sides.

Metal strips are coated using liquid, heat-curable coating compositions which are composed of a solution of a hydroxyl-containing binder, a polyester for example, and a blocked polyisocyanate and/or a melamine resin, and derivatives thereof, in an organic solvent. Further constituents that may be mentioned include pigments and other additives.

Important properties for coatings on metal strips are those such as weathering resistance, resistance to hydrolysis, chemical resistance and scratch resistance, and high gloss, hardness and flexibility. The latter has a strong influence on the adhesion properties of the coating if the substrate, after the painting operation, is subjected to one or more deformation steps, such as deep drawing, for example, as is necessary for numerous components.

The weathering resistance is critical for those components in particular whose surface is exposed to direct solar radiation and other weather effects; such components include traffic signs, architectural facing elements, garage doors, gutters and automotive parts, etc.

In principle, the substrate adhesion is better with softer and more flexible binders, while the weathering resistance and durability are better with harder binders.

Besides all of these properties, there is one factor in the coating of metal strips that is accorded a very considerable place: the economics. Thus it is desirable to coat as long as possible a section of metal strip per unit time. Limiting variables here are the residence time of the metal strips in the oven and the oven temperature required for complete crosslinking of the paints. It is general knowledge that, the lower the molar mass of the polymers employed, i.e. the greater the density of crosslinkable groups, hydroxyl groups for example, the shorter are the oven residence times of metal sheets coated in this way, i.e. the greater the crosslinking reactivity of the binders employed. An arbitrary lowering of the molecular weight and associated high crosslinking density are opposed, however, by an embrittlement of the finished paint coatings that is unacceptable for the coating of metal strips, particularly if melamine compounds are used as crosslinkers.

Another way of achieving shorter baking times is by means of increased oven temperatures. Besides the associated higher energy costs, which are not an aim, with many substrates it is not possible to realise arbitrarily high temperatures. Steels referred to as BH (bake hardening) steels, for example, cure at relatively high temperatures, and for that reason can no longer be subjected to a deformation step.

In order to ensure these required properties of economics and paint quality, it is prior art (WO 2004/039902) to use blends of a branched binder of relatively low molecular weight with a predominantly linear binder of higher molecular weight in order to achieve flexibilization, together with a crosslinker, in metal strip coatings. Formulas of this kind can be used to ensure that the paint possesses a sufficiently high crosslinking reactivity in the oven.

The necessity of preparing two different binders and, ultimately, of blending them in the appropriate ratio in order to formulate the paints is synonymous with considerable economic disadvantages as compared with a paint formula based on a single binder.

For these reasons it was an object of the present invention to develop a method and a coating for metal strips that leads to the aforementioned paint properties and at the same time offers sufficiently high crosslinking reactivity to allow very low oven residence times for a moderate quantity of crosslinker. It is general knowledge that the crosslinking reactivity of OH-terminated polyesters increases as the OH number goes up. Nevertheless, polyesters having high OH numbers, i.e. low molecular weights, yield brittle paint films, whose lack of flexibility means they cannot be used for coating metal strips.

Surprisingly it has been found that branched polyesters having trifunctional branching agent contents of between 10 and 25 mol %, based on the alcohol component, with a molecular weight between 2500 and 4500 g/mol, have a relationship between high crosslinking reactivity and flexibility that is sufficiently well-balanced for the coating of metal strips. Branched polyesters of this kind are described in EP 1479709.

The present invention accordingly provides the use of branched, amorphous, polyester-based macropolyols obtained by reacting at least one carboxylic acid component and at least one alcohol component comprising 10 to 25 mol % of an at least trifunctional alcohol and 75 to 90 mol % of at least one further alcohol, based on the alcohol component, in the presence of a crosslinking reagent, the polyester having
an Mₙ of 2500-4500 g/mol,
an OH number of 0-200 mg KOH/g and
an acid number of 0 to 10 mg KOH/g, for coating metal strips.

The amorphous, branched, polyester-based macropolyols used in accordance with the invention comprise as starting acid component at least one aromatic and/or aliphatic dicarboxylic acid and/or polycarboxylic acid, such as phthalic acid, isophthalic acid, terephthalic acid, cycloaliphatic 1,2-dicarboxylic acid such as 1,2-cyclohexanedicarboxylic acid and/or methyltetra-hydro-, tetrahydro- and/or methylhexahydrophthalic acid, succinic acid, sebacic acid, undecanedioic acid, dodecanedioic acid, adipic acid, azelaic acid, pyromellitic acid, trimellitic acid, isononanoic acid and/or dimer fatty acid. Preference is given to isophthalic acid, 1,2-cyclohexanedicarboxylic acid, phthalic acid and adipic acid.

Each acid component may be composed partly or wholly of anhydrides and/or low molecular weight alkyl esters, preferably methyl esters and/or ethyl esters.

As an at least trifunctional alcohol component it is possible for example to use trimethylolpropane, trimethylolethane, 1,2,6-trihydroxyhexaerythritol, glycerol, trishydroxyethyl isocyanurate, penta-erythritol, sorbitol, xylitol and/or mannitol, in amounts from 10 to 25 mol %, based on the alcohol component.

In addition the alcohol component may comprise further linear and/or branched, aliphatic and/or cycloaliphatic and/or aromatic diols and/or polyols. Preferred additional alcohols used are ethylene glycol, 1,2- and/or 1,3-propanediol, diethylene glycol, dipropylene glycol, triethylene glycol, tetraethylene glycol, 1,2- and/or 1,4-butanediol, 1,3-butylethylpropanediol, 1,3-methylpropanediol, 1,5-pentanediol, bisphenol A, B, C, F, norbornylene glycol, 1,4-benzyldimethanol and -ethanol, 2,4-dimethyl-2-ethylhexane-1,3-diol, cyclohexanedimethanol, Dicidol, hexanediol, neopentyl glycol in amounts from 75 to 90 mol %, based on the alcohol component.

Preferred acids are, for example, 1,2-cyclohexanedicarboxylic acid, phthalic acid and/or adipic acid, more particularly in the following composition:

92-100 mol % 1,2-cyclohexanedicarboxylic acid and 0-8 mol % phthalic acid and/or adipic acid or
60-70 mol % phthalic acid and 30-40 mol % adipic acid.

Preferred diols are, for example, ethylene glycol (0-40 mol %), 2,2′-dimethylpropane-1,3-diol (35-80 mol %), 1,6-hexanediol (0-15 mol %), trimethylolpropane (10-25 mol %).

The branched, amorphous macropolyols may have an acid number of less than 15.0 mg KOH/g, preferably less than 10.0, more preferably between 0 and 5 mg KOH/g and also a hydroxyl number of between 0 and 200 mg KOH/g, preferably between 10 and 150, more preferably between 30 and 100 mg KOH/g.

The resulting number-averaged molecular weights Mₙ are from 2500 to 4500 g/mol, preferably 3000 to 4000.

The acid number is determined in accordance with DIN EN ISO 2114.

By the acid number (AN) is meant the amount of potassium hydroxide, in mg, which is needed to neutralize the acids present in one gram of substance. The sample for analysis is dissolved in dichloromethane and titrated with 0.1 N methanolic potassium hydroxide solution against phenolphthalein.

The hydroxyl number is determined in accordance with DIN 53240-2.

In this method the sample is reacted with acetic anhydride in the presence of a 4-dimethylaminopyridine catalyst, the hydroxyl groups being acetylated. This produces one molecule of acetic acid per hydroxyl group, while the subsequent hydrolysis of the excess acetic anhydride yields two molecules of acetic acid. The consumption of acetic acid is determined by titrimetry from the difference between the main value and a blank value to be carried out in parallel.

The molecular weight is determined by means of gel permeation chromatography (GPC). The samples were characterized in tetrahydrofuran eluent in accordance with DIN 55672-1.

Mₙ (UV)=number−average molar weight (GPC, UV detection), result in g/mol
M_{w} (UV)=mass−average molar weight (GPC, UV detection), result in g/mol

The coated metal strips obtained in accordance with the invention display advantageous properties; in particular, the coatings exhibit values <2.0 in the T-bend test.

### SUMMARY OF THE INVENTION

The invention provides the use of branched, amorphous, polyester-based macropolyols for coating metal strips. The coating composition used is characterized as follows:

It comprises a branched, amorphous, polyester-based macropolyol which is obtainable by reacting
at least one carboxylic acid component from the group of aromatic and/or aliphatic dicarboxylic acids and/or polycarboxylic acids, such as phthalic acid, isophthalic acid, terephthalic acid, cycloaliphatic dicarboxylic acids such as 1,2-, 1,3-, 1,4-cyclohexanedicarboxylic acid and/or methyltetrahydro-, tetrahydro- and/or methylhexahydrophthalic acid, succinic acid, sebacic acid, dodecanedioic acid, adipic acid, azelaic acid, undecanedioic acid, pyromellitic acid, trimellitic acid, isononanoic acid and/or dimer fatty acid, preferably isophthalic acid, 1,2-cyclohexanedicarboxylic acid, phthalic acid and/or adipic acid
and
at least one alcohol component comprising
1) 10 to 25 mol % of an at least trifunctional alcohol
   and
2) 75 to 90 mol % of an at least one further diol,
   in the presence of a crosslinking reagent, characterized by
an Mₙ of 2500-4500 g/mol,
an OH number of 0-200 mg KOH/g, preferably of 20-150 mg KOH/g and more preferably of 30-100 mg KOH/g,
an acid number of 0 to 10 mg KOH/g, preferably of 0-15 mg KOH/g and more preferably of 0-5 mg KOH/g.

The crosslinking reagent is, for example, a polyisocyanate and/or a melamine resin and/or derivatives thereof.

For coating, in addition, the amorphous, polyester-based macropolyols can be used together with 0% to 70% by weight, based on the overall composition, of auxiliaries and additives, more particularly with inhibitors, water and/or organic solvents, neutralizing agents, surface-active substances, oxygen scavengers and/or free-radical scavengers, catalysts, light stabilizers, colour brighteners, photosensitizers, thixotropic agents, anti-skinning agents, defoamers, antistats, thickeners, thermoplastic additives, dyes, pigments, flame retardants, internal release agents, fillers and/or blowing agents.

With regard to the metals to be coated there are no restrictions; in particular, the metal of the metal strips is selected from the group consisting of aluminium, steel and zinc.

Likewise provided by the present invention are methods of coating metal strips, the coating material being composed of a branched, amorphous, polyester-based macropolyol obtained by reacting at least one carboxylic acid component and at least one alcohol component comprising 10 to 25 mol % of an at least trifunctional alcohol and 75 to 90 mol % of at least one further alcohol, based on the alcohol component, in the presence of a crosslinking reagent, the polyester having
an Mₙ of 2500-4500 g/mol,
an OH number of 0-200 mg KOH/g and
an acid number of 0 to 10 mg KOH/g,
   the coating material on the metal strips being baked at baking temperatures of less than 220° C. (Peak Metal Temperature PMT).

The resultant coatings on metal strips exhibit values <2.0 in the T-bend test.

The branched, amorphous, polyester-based macropolyols used in accordance with the invention are prepared by known methods (see Dr P. Oldring, Resins for surface Coatings, Volume III, published by Sita Technology, 203 Gardiner House, Broomhill Road, London SW18 4JQ, England 1987) by means of (semi-) batchwise or discontinuous esterification of the starting acids and starting alcohols in a single-stage or multi-stage procedure.

The amorphous, polyester-based macropolyols used in accordance with the invention are prepared preferably in an inert gas atmosphere at 150 to 270° C., preferably at 180 to 260° C., more preferably at 200 to 250° C. The inert gas used may be nitrogen or noble gases, more particularly nitrogen. The inert gas has an oxygen content of less than 50 ppm, more particularly less than 20 ppm. After the major fraction of the theoretically calculated amount of water has been eliminated, it is possible to operate with reduced pressure. Optionally it is also possible to operate with addition of catalysts in order to accelerate the (poly)condensation reaction and/or of entrainers in order to separate off the water of reaction. Typical catalysts are organotitanium or organotin compounds, such as tetrabutyl titanate or dibutyltin oxide, for example. The catalysts can be charged optionally at the beginning of the reaction, with the other starting materials, or not until later, during the reaction. As entrainers it is possible to make use, for example, of toluene or various SolventNaphtha® grades.

The metal strips coated in accordance with the invention are likewise provided with the present invention and can be used in any desired way envisaged by the skilled person, more particularly in construction and in architecture (for example, interior applications, roof, wall), in transportation, in household appliances, and in further processing, punching or perforating for example.

Even without further observations it is assumed that a skilled person is able to utilize the above description to its widest extent. The preferred embodiments and examples, consequently, are to be interpreted merely as a descriptive disclosure which does not have any limiting effect whatsoever.

Below, the present invention is illustrated by means of examples. Alternative embodiments of the present invention are obtainable analogously.

### EXAMPLE 1

| | | |
|---|---|---|
| Mol % | % by weight | Ingredient |

Acid component

| | | |
|---|---|---|
| 100 | 59.9 | 1,2-Cyclohexanedicarboxylic anhydride |
| 100 | | Total acid component |

Alcohol component

| | | |
|---|---|---|
| 30 | 7.5 | Neopentyl glycol |
| 39 | 10.3 | Monoethylene glycol |
| 15 | 13.2 | 1,6-Hexanediol |
| 16 | 9.1 | Trimethylolpropane |
| 100 | | Total alcohol component |

59.9 parts of 1,2-cyclohexanedicarboxylic anhydride are reacted with 7.5 parts of neopentyl glycol, 10.3 parts of monoethylene glycol, 13.2 parts of 1,6-hexanediol and 9.1 parts of trimethylolpropane at a maximum temperature of 250° C. in a nitrogen atmosphere until an acid number below 1 mg KOH/g and a hydroxyl number of 55 mg KOH/g is reached. After cooling, the polyester is dissolved at 65% in Solvesso® 150/butyl glycol (3:1).

### Key Analytical Data:

OHN=55 mg KOH·g⁻¹, AN=0.4 mg KOH·g⁻¹, Mₙ=3600 g·mol⁻¹

### EXAMPLE 2

| | | |
|---|---|---|
| Mol % | % by weight | Ingredient |

Acid component

| | | |
|---|---|---|
| 100 | 55.2 | 1,2-Cyclohexanedicarboxylic anhydride |
| 100 | | Total acid component |

Alcohol component

| | | |
|---|---|---|
| 77.5 | 32.6 | Neopentyl glycol |
| 22.5 | 12.2 | Trimethylolpropane |
| 100 | | Total alcohol component |

55.2 parts of 1,2-cyclohexanedicarboxylic anhydride are reacted with 32.6 parts of neopentyl glycol and 12.2 parts of trimethylolpropane at a maximum temperature of 250° C. in a nitrogen atmosphere until an acid number of 5 mg KOH/g is reached. After cooling, the polyester is dissolved at 65% in Solvesso® 150/butyl glycol (3:1).

### Key Analytical Data:

OHN=95 mg KOH·g⁻¹, AN=5 mg KOH·g⁻¹, Mₙ=2500 g·mol⁻¹

### EXAMPLE 3

| | | |
|---|---|---|
| Mol % | % by weight | Ingredient |

Acid component

| | | |
|---|---|---|
| 70 | 34.6 | Phthalic acid |
| 30 | 15.1 | Adipic acid |
| 100 | | Total acid component |

Alcohol component

| | | |
|---|---|---|
| 60.0 | 30.2 | Neopentyl glycol |
| 25 | 12.5 | Monoethylene glycol |
| 15 | 7.6 | Trimethylolpropane |
| 100 | | Total alcohol component |

34.6 parts of phthalic acid and 15.1 parts of adipic acid are reacted with 30.2 parts of neopentyl glycol, 12.5 parts of monoethylene glycol and 7.6 parts of trimethylolpropane at a maximum temperature of 250° C. in a nitrogen atmosphere until an acid number below 1 mg KOH/g and a hydroxyl number of 35 mg KOH/g is reached. After cooling, the polyester is dissolved at 65% in Solvesso® 150/butyl glycol (3:1).

### Key Analytical Data:

OHN=35 mg KOH·g⁻¹, AN=0.6 mg KOH·g⁻¹, Mₙ=4100 g·mol⁻¹

### COMPARATIVE EXAMPLE A

| | | |
|---|---|---|
| Mol % | % by weight | Ingredient |

Acid component

| | | |
|---|---|---|
| 100 | 50 | 1,2-Cyclohexanedicarboxylic anhydride |
| 100 | | Total acid component |

Alcohol component

| | | |
|---|---|---|
| 97.5 | 48.8 | Neopentyl glycol |
| 2.5 | 1.2 | Trimethylolpropane |
| 100 | | Total alcohol component |

50 parts of 1,2-cyclohexanedicarboxylic anhydride are reacted with 48.8 parts of neopentyl glycol and 1.2 parts of trimethylolpropane at a maximum temperature of 250° C. in a nitrogen atmosphere until an acid number below 5 mg KOH/g and a hydroxyl number of 47 mg KOH/g are reached. After cooling, the polyester is dissolved at 65% in Solvesso® 100.

### Key Analytical Data:

OHN=47 mg KOH·g⁻¹, AN=4.0 mg KOH·g⁻¹, Mₙ=2100 g·mol⁻¹

### COMPARATIVE EXAMPLE B

| | | |
|---|---|---|
| Mol % | % by weight | Ingredient |

Acid component

| | | |
|---|---|---|
| 100 | 53.5 | 1,2-Cyclohexanedicarboxylic anhydride |
| 100 | | Total acid component |

Alcohol component

| | | |
|---|---|---|
| 77.5 | 33.8 | Neopentyl glycol |
| 22.5 | 12.7 | Trimethylolpropane |
| 100 | | Total alcohol component |

53.5 parts of 1,2-cyclohexanedicarboxylic anhydride are reacted with 33.8 parts of neopentyl glycol and 12.7 parts of trimethylolpropane at a maximum temperature of 250° C. in a nitrogen atmosphere until an acid number of 5 mg KOH/g and a hydroxyl number of 128 mg KOH/g are reached. After cooling, the polyester is dissolved at 65% in Solvesso® 150/butyl glycol (3:1).

### Key Analytical Data:

OHN=128 mg KOH·g⁻¹, AN=5 mg KOH·g⁻¹, Mₙ=2400 g·mol⁻¹

### COMPARATIVE EXAMPLE C

| | | |
|---|---|---|
| Mol % | % by weight | Ingredient |

Acid component

| | | |
|---|---|---|
| 100 | 50 | 1,2-Cyclohexanedicarboxylic anhydride |
| 100 | | Total acid component |

Alcohol component

| | | |
|---|---|---|
| 74 | 36.8 | Neopentyl glycol |
| 26 | 13.2 | Trimethylolpropane |
| 100 | | Total alcohol component |

50 parts of 1,2-cyclohexanedicarboxylic anhydride are reacted with 36.8 parts of neopentyl glycol and 13.2 parts of trimethylolpropane at a maximum temperature of 250° C. in a nitrogen atmosphere until an acid number of 5 mg KOH/g and a hydroxyl number of 110 mg KOH/g are reached. After cooling, the polyester is dissolved at 65% in Solvesso® 100.

### Key Analytical Data:

OHN=110 mg KOH·g⁻¹, AN=5.1 mg KOH·g⁻¹, Mₙ=2200 g·mol⁻¹

### Paint Formulas

| | Parts |
|---|---|
| Polyester solution 65% | 43.8 |
| TiO₂ 2310 | 31.7 |
| Hexamethoxymethylmelamine¹ | 7.5 |
| p-Toluenesulphonic acid² | 0.4 |
| Flow control assistant³ | 0.8 |
| Butyl glycol acetate | 8.6 |
| DBE | 7.2 |

¹e.g. Cymel 303 from Cytec Industries Inc.; this crosslinker is notable in that its reactive NH₂ groups are blocked by methoxy groups, which are eliminated again at elevated temperatures, common in the coil coating process, and the reaction with the polyesters can take place.
²e.g. Nacure 2500 from King Industries, Inc.; this acidic catalyst (chemically blocked) is needed in order to allow the reaction between melamine component and polyester component.
³e.g. Byk 350 from Byk-Chemie; acrylate additive for improving the flow and increasing the gloss. The additive provides “long wave” levelling performance and prevents craters. It causes only slight reduction in surface tension and exhibits no negative influence on recoatability and intercoat adhesion.

### Paint Testing

| | Paint | Paint | Paint | Paint | Paint | Paint |
|---|---|---|---|---|---|---|
| | Ex. 1 | Ex. 2 | Ex. 3 | Comp. A | Comp. B | Comp. C |
| MEK¹ | >100 | >100 | >100 | >100 | >100 | >100 |
| double rubs | | | | | | |
| PMT² [° C.] | 209 | 216 | 188 | 232 | 209 | 204 |
| T-bend³ | 1.5 | 1.5 | 1.0 | 1.0 | 3.0 | 3.0 |

### Methods:

1 ECCA test method T11: (This test method makes it possible to test the crosslinking of a reactive paint system under the underlying baking conditions.)

Procedure:
The coated “panel”, consisting of aluminium or galvanized steel or the like, is exposed chemically/mechanically using a cotton pad impregnated with methyl ethyl ketone (MEK) (with a 1 or 2 kg weight (MEK hammer)). The exposure involves linear double rubs, in the course of which there may be chemical attack on the coating. Generally speaking, a coating which has undergone full curing through its volume ought to withstand 100 double rubs (DR) without damage. If volume curing is inadequate, the paint breaks up after the first few double rubs, or possibly later (<100 DR). The number of double rubs attained accordingly is counted, as a whole number, and reported as a measure, for example, of the volume curing or crosslinking density or reactivity of a paint system.
2 Peak Metal Temperature (maximum temperature measured on the panel surface during the baking operation)
3 ECCA test method T5: The purpose of these operating instructions is the assessment of the extensibility and the strength of adhesion of coatings under flexural load. The smallest radius of flexure that allows crack-free bending of the sample determines the resistance in the case of a 180° bend.

Procedure:

Determining the T-Bend of an Unloaded Sample

The sample plates must be planar and free from deformations (e.g. creases).

The metal test panels are pre-bent, with the coating facing outwards, by hand, using the folding bench, by about 180°.

For this purpose the panel, with a maximum width of 10 cm, is inserted, with the painted side towards the back, into the smallest possible slot of a bending bench.

Thereafter the pre-bent panel is pressed together firmly in a vice, so that there is no longer any air gap.

The shoulder of flexure is examined for cracks using a magnifier which enlarges 10 times.

Thereafter, a strip of tesafilm adhesive tape is pressed on firmly over the whole width of the shoulder of flexure, then torn off sharply and inspected for adhering paint particles.

A determination is made of the smallest radius of flexure (0 T-0.5 T-1 T, and so on) at which the paint film exhibits no cracks (T-bend cracks) and at which no paint detachment (T-bend adhesion) can be observed on the adhesive tape.

1. Use of a branched, amorphous, polyester-based macropolyol obtained by reacting at least one carboxylic acid component and at least one alcohol component comprising 10 to 25 mol % of an at least trifunctional alcohol and 75 to 90 mol % of at least one further alcohol, based on the alcohol component, in the presence of a crosslinking reagent, the polyester having
an Mₙ of 2500-4500 g/mol,
an OH number of 0-200 mg KOH/g and
an acid number of 0 to 10 mg KOH/g, for coating a metal strip.

2. Use according to claim 1, characterized in that the at least one carboxylic acid component is selected from the group of aromatic and/or aliphatic dicarboxylic acids and/or polycarboxylic acids.

3. Use according to claim 1, characterized in that the carboxylic acid component is phthalic acid, isophthalic acid, terephthalic acid, cyclo-aliphatic dicarboxylic acids such as 1,2-, 1,3-, 1,4-cyclohexanedicarboxylic acid and/or methyltetrahydro-, tetrahydro- and/or methylhexahydrophthalic acid, succinic acid, sebacic acid, undecanedioic acid, dodecanedioic acid, adipic acid, azelaic acid, pyromellitic acid, trimellitic acid, isononanoic acid and/or dimer fatty acid, preferably isophthalic acid, 1,2-cyclohexanedicarboxylic acid, phthalic acid or adipic acid.

4. Use according to claim 1, characterized in that trimethylolpropane, trimethylolethane, 1,2,6-trihydroxyhexaerythritol, glycerol, trishydroxyethyl isocyanurate, pentaerythritol, sorbitol, xylitol and/or mannitol is used as trifunctional alcohol component.

5. Use according to claim 1, characterized in that linear and/or branched, aliphatic and/or cycloaliphatic and/or aromatic diols and/or polyols are used as further alcohol component.

6. Use according to claim 5, characterized in that the further alcohol component is selected from ethylene glycol, 1,2- and/or 1,3-propanediol, diethylene glycol, dipropylene glycol, triethylene glycol, tetraethylene glycol, 1,2- and/or 1,4-butanediol, 1,3-butylethylpropanediol, 1,3-methylpropanediol, 1,5-pentanediol, bisphenol A, B, C, F, norbornylene glycol, 1,4-benzyldimethanol and -ethanol, 2,4-dimethyl-2-ethylhexane-1,3-diol, cyclohexanedimethanol, Dicidol, hexanediol.

7. Use according to claim 1, characterized in that polyisocyanate and/or a melamine resin and/or derivative thereof is used as crosslinking reagent.

8. Use according to claim 1, characterized in that the resultant coating on metal strip exhibits a value <2.0 in the T-bend test.

9. Use according to claim 1, characterized in that the branched, amorphous, polyester-based macropolyol is used together with auxiliaries and additives.

10. Use according to claim 9, characterized in that the auxiliaries and additives are selected from the group consisting of inhibitors, water and/or organic solvents, neutralizing agents, surface-active substances, oxygen scavengers and/or free-radical scavengers, catalysts, light stabilizers, colour brighteners, photosensitizers, thixotropic agents, anti-skinning agents, defoamers, antistats, thickeners, thermoplastic additives, dyes, pigments, flame retardants, internal release agents, fillers and/or blowing agents.

11. Use according to claim 1, characterized in that the metal of the metal strip is selected from the group consisting of aluminium, steel and zinc.

12. A method of coating a metal strip, comprising coating a metal strip with a coating material comprising a branched, amorphous, polyester-based macropolyol obtained by reacting at least one carboxylic acid component and at least one alcohol component comprising 10 to 25 mol % of an at least trifunctional alcohol and 75 to 90 mol % of at least one further alcohol, based on the alcohol component, in the presence of a crosslinking reagent, the polyester having
an Mₙ of 2500-4500 g/mol,
an OH number of 0-200 mg KOH/g and
an acid number of 0 to 10 mg KOH/g, and
baking the coating material on the metal strip at baking temperatures of less than 220° C. (PMT).

13. The method according to claim 12, wherein the resultant coating on metal strip exhibits a value <2.0 in the T-bend test.

14. The method according to claim 12, wherein up to 70% by weight of further auxiliaries and additives are present.

15. The method according to claim 14, wherein the auxiliary and additive are each at least one member selected from the group consisting of an inhibitor, water, an organic solvent, a neutralizing agent, a surface-active substance, an oxygen scavenger, a free-radical scavenger, a catalyst, a light stabilizer, a color brightener, a photosensitizer, a thixotropic agent, an anti-skinning agent, a defoamer, an antistat, a thickener, a thermoplastic additive, a dye, a pigment, a flame retardant, an internal release agent, a filler, and a blowing agent.

16. A coated metal strip obtained by the method according to claim 12.
